(19) United States
(12) Patent Application Publication
(10) Pub. No.: US 2015/0020753 A1
(43) Pub. Date: Jan. 22, 2015

(54) Multiple Animal Leash System with Internal Handholds

(71) Applicant: Alexandro Gracia, Culver City, CA (US)

(72) Inventor: Alexandro Gracia, Culver City, CA (US)

(21) Appl. No.: 13/946,962

(22) Filed: Jul. 19, 2013

(51) Int. Cl. A01K 27/00

(52) U.S. Cl. CPC A01K 27/003
USPC 119/795; 119/797

(57) ABSTRACT

A multiple animal leash system with internal handholds includes two strips of flexible material, bound together; the ends having hold loops and a attachment clasps; two binding sections near the ends of the leash each having bindings joining the strips with a first, small interval between each binding to provide attachment apertures adapted to be retained by the attachment clasps; and a binding section at and around the center of the leash having a second plurality of bindings joining the strips of flexible material, having a second interval between each binding to provide hand-hold apertures adapted to be retained by a user's hand.

### BACKGROUND OF THE INVENTION

The present invention generally relates to animal leashes and more specifically to a leash system for multiple animals that has internal handholds.

Tethering systems exist for multiple dogs, but they generally do not have apertures in which the user can insert his hands and easily retain the leash. Existing leashes may have “stops” on the outside of a “rope” to help prevent a user's hand from slipping, but they do not have apertures within the leash which the user may utilize to easily, conveniently hold the leash without constantly firmly grasping the rope. Existing systems may require a carabiner for adjustment.

It would be desirable to have a leash for multiple dogs or pets that can easily be grasped with either one or both hands.

### SUMMARY OF THE INVENTION

In one aspect of the present invention, a device utilizing a hand of a user includes two strips of flexible material, bound together to form a leash; a first end of the leash having a hand hold loop and a first attachment clasp; a second end of the leash having a second attachment clasp; a first binding section near the first end of the leash having a first plurality of bindings joining the strips, the space between each binding providing an attachment aperture adapted to be retained by the second attachment clasp; and a second binding section at and around the center of the leash having a second plurality of bindings joining the strips of flexible material, the space between each binding providing a hand-hold aperture adapted to be retained by the hand of the user.

In another aspect of the present invention, a leash includes two strips of flexible material, bound together; a first end of the leash having a first hand hold loop and a first attachment clasp; a second end of the leash having a second hand hold loop and a second attachment clasp; a first binding section near the first end of the leash having a first plurality of bindings joining the strips, having a first interval between each binding to provide attachment apertures adapted to be retained by the second attachment clasp; a second binding section at and around the center of the leash having a second plurality of bindings joining the strips of flexible material, having a second interval between each binding to provide hand-hold apertures adapted to be retained by a user's hand; and a third binding section near the second end of the leash having a third plurality of bindings joining the strips, having the first interval between each binding to provide attachment apertures adapted to be retained by the first attachment clasp; wherein the first binding section and the third section binding section have substantially the same dimensions so that the leash is symmetrical.

In yet another aspect of the present invention, a method of handling two animals includes providing a leash having two strips of flexible material, bound together, a first end of the leash having a hand hold loop and a first attachment clasp, a second end of the leash having a second attachment clasp, a first binding section near the first end of the leash having a first plurality of bindings joining the strips, the space between each binding providing an attachment aperture adapted to be retained by the second attachment clasp, and a second binding section at and around the center of the leash having a second plurality of bindings joining the strips of flexible material, the space between each binding providing a hand-hold aperture adapted to be retained by the hand of the user; attaching a first animal to the first end of the leash utilizing the first attachment clasp; attaching a second animal to the second end of the leash utilizing the second attachment clasp; and inserting the user's hand into one of the hand-hold apertures thereby allowing the user to handle both animals.

### BRIEF DESCRIPTION OF THE DRAWINGS

FIG. 1 depicts a side view of an embodiment of the present invention;

FIG. 2 depicts a top view of the embodiment of FIG. 1;

FIG. 3 depicts a perspective view of the embodiment of FIG. 1;

FIG. 4 depicts an alternate embodiment of the present invention; and

FIG. 5 depicts the embodiment of FIG. 1 in use.

### DETAILED DESCRIPTION

The preferred embodiment and other embodiments, which can be used in industry and include the best mode now known of carrying out the invention, are hereby described in detail with reference to the drawings. Further embodiments, features and advantages will become apparent from the ensuing description, or may be learned without undue experimentation. The figures are not necessarily drawn to scale, except where otherwise indicated. The following description of embodiments, even if phrased in terms of “the invention” or what the embodiment “is,” is not to be taken in a limiting sense, but describes the manner and process of making and using the invention. The coverage of this patent will be described in the claims. The order in which steps are listed in the claims does not necessarily indicate that the steps must be performed in that order.

An embodiment of the present invention generally provides a leash system with multiple, internal handholds. The user may tether objects to both ends of the leash, such as dogs, children, pets, animals, robots, or other objects that may tend to roam, and may retain and control the tethered objects by inserting one or more hands into the internal handholds of the leash.

Embodiments may include a leash for 1 or 2 dogs, made from 2 strips of strong, flexible material (e.g. nylon or leather), stitched or otherwise bound together at 6″ intervals to form a tether. The unstitched space between the strips provides multiple hand holds for the user. The hand thus goes inside the interior portion of the leash, and the stitching forms a series of hand-sized gripping apertures. One or both ends may also each have a loop for a traditional leash hand hold, formed by looping the section of material back onto itself and having a reinforced binding such as cross-stitching. Each loop at the ends of the tether has a swiveled clasp, to releasably attach to a dog's collar or harness. The clasps can also attach to the tether itself and form a loop which can either retain one end of the tether, e.g. to a pole or around a user's waist or shoulder, provide a fixed-size collar, or provide a varying-size “choke” collar. An end of the leash may wrap around an animal's neck and body and then the clasp can be attached to the tether to create a harness.

In an embodiment, the tolerance for the reinforced stitching for a 6″ hand hold may be 0.5 inches to 1 inch, and the material may be cross-stitched for strength. Instead of stitching, the material may otherwise be bound to itself, such as by gluing or melting. In an embodiment, the outer layer or ply of material may be approximately 75% as wide as the inner layer. The tether is neither rigid nor significantly stretchable. Instead of a user's hand, a leash extension could be attached to one of the hand holds. The clasp may be a snap spring hook that snaps onto an attachment (such as a ring on a dog collar) simply by pressing the snap against the attachment, and may be released by pressing the snap down with the user's thumb. Even if the user lets go for a second, the leash may still be retained to the hand. Embodiments of a strip of flexible may include nylon, leather, or other materials suitable for a leash. A leash may be a tether, used to hold a dog or other animal to be walked or at least kept in place. An attachment clasp may be permanently fixed to an end of the leash, and may include a carabiner or spring-lock clip.

Embodiment may have a hand hold loop with a first stitching, and then further stitching at from 0.8 to 2.5 inch intervals, preferably 2 inches, in a 1 foot section. The clasp at the end may be attached to any of the 2-inch intervals to form a fixed-size loop or collar. This small 2 inch size may provide a reasonably large number of attachment points, while providing enough room to conveniently attach the clasp. The clasp may be attached to form a small loop around the body of the leash, so that that the leash forms a choke collar (without requiring that the user drawn the body of the leash through a fixed loop). The user may also attach the clasp to the first loop near the same end as the clasp, so that the clasp is stored when not needed.

In an embodiment, hand holds at one or both ends are formed by one piece of the flexible material, looped back on itself and stitched or otherwise bound together. The first stitching may include cross stitching for strength. The leash may be made of a single piece of material that is looped back on itself from both ends, or from 2 pieces of material bound together. The ends of a single strip or flat cord of nylon or leather may overlap for a short distances, such as 1-2″, to form a small triple-layer section. The hand hold loop may join the leash in a reinforced area for about the same interval, or for the same as the clasp attachment interval.

If two sections of material are used, one section may be wider than the other, so that either one side of the interior hand holds is smaller than the other or one hand hold loop at an end is smaller than the hand hold loop at the opposite end (or both).

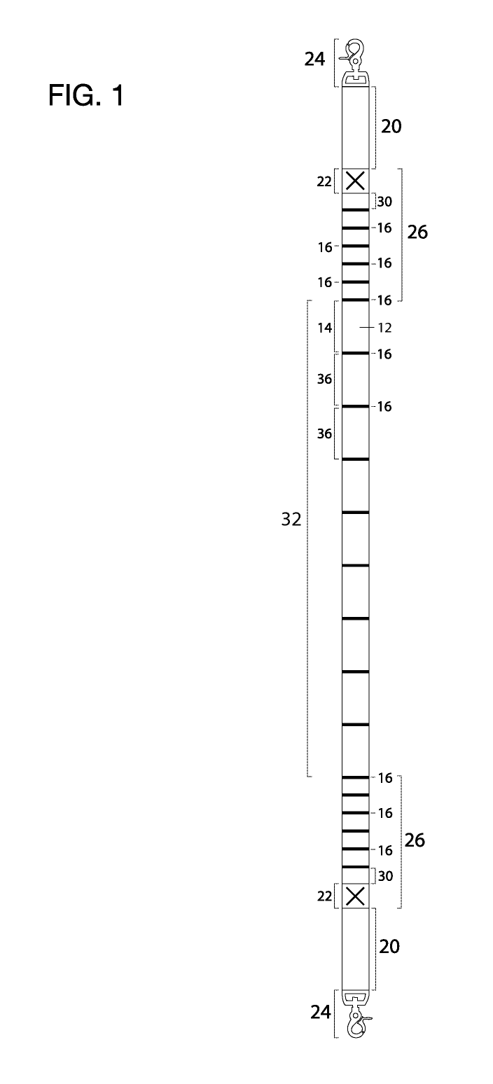

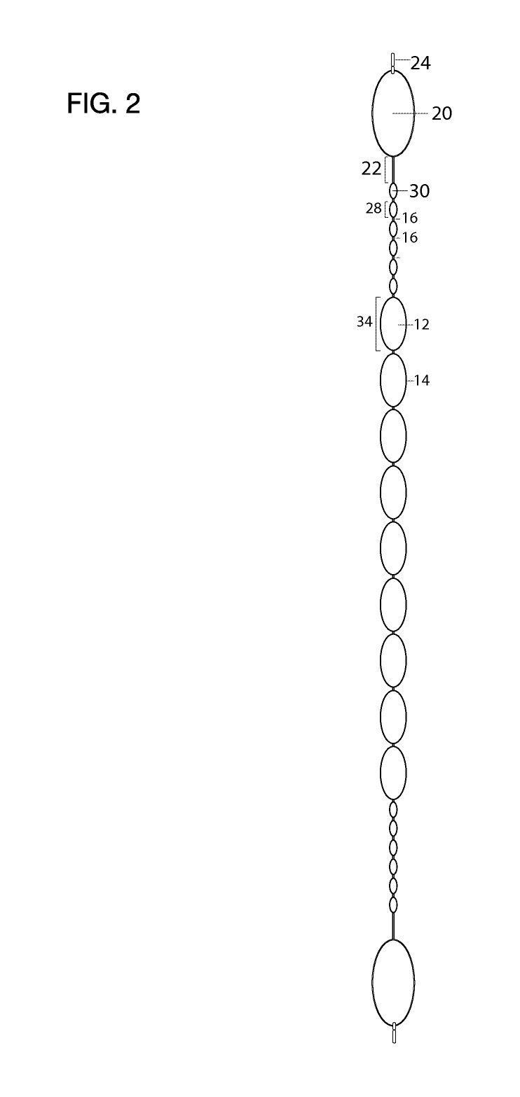

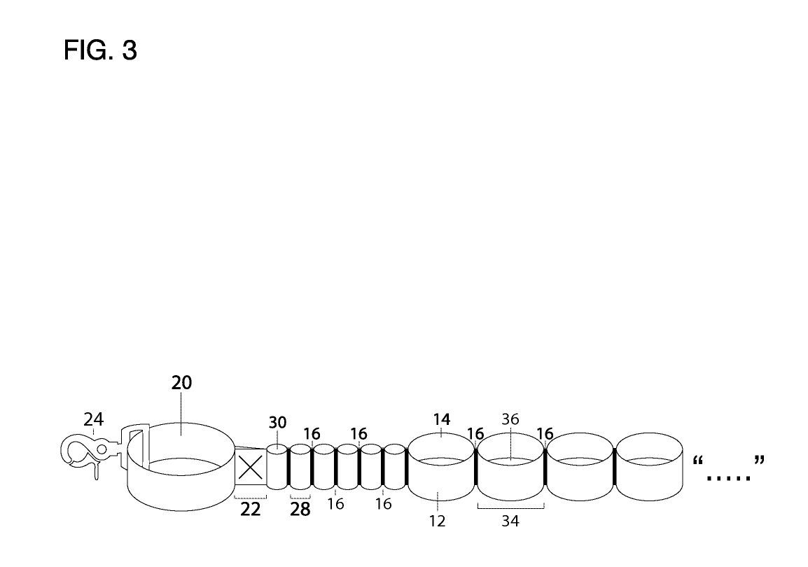

As depicted in FIGS. 1-3, an embodiment of a leash 10 may include a first strip of flexible material 12 and a second strip of flexible material 14, bound together with stitches 16 at specified intervals to form a leash 10 with hand hold loops 20 at its ends.

The two strips 12, 14 may be a single, long piece of material looped back onto itself. One strip 12 may form a hand hold loop 20 at the end of leash 10 by looping back on itself and then being bound with reinforced binding 22 such as cross-stitching. A similar hand hold loop 20 may be formed on the opposite side of leash 10, either with the same first strip of flexible material 12 or with a second strip of flexible material 14. Each hand hold loop 20 has a clasp 24 that can be used to attach to an animal's collar, or to the tether 12 itself.

Two attachment sections 26 may be formed at each end of the leash 10, by stitching the flexible materials 12, 14 together at a relatively small attachment section intervals 28, such as 2 inches, to a distance of approximately 1 foot from either end of the leash 10. The spaces between the stitches 16 form relatively small attachment apertures 30, to which the clasp 24 may be releasably attached. The first attachment aperture 30 at the end of the leash may be further adapted to retain the clasp 24 at the same end, thereby retaining the clasp 24 on leash 10 for storage of the clasp.

An interior hand hold section 32 may be formed on the leash 10 between the attachment sections 26 by stitching the flexible materials 12, 14 together at hand hold intervals 34, which are approximately 6 inches. The spaces between the stitches 16 form hand-sized attachment apertures 36. The user may easily retain the leash 10 by inserting one or both hands into the apertures 36, and even if the user briefly lets go or relaxes his grip, his hands will tend to continue to retain leash 10. The two attachments sections 26 and the hand hold section 32 are binding sections with different aperture sizes that are spaced and sized either for attaching to a clasp or for the user's hand. The binding section may have the same dimensions so that the leash is symmetrical.

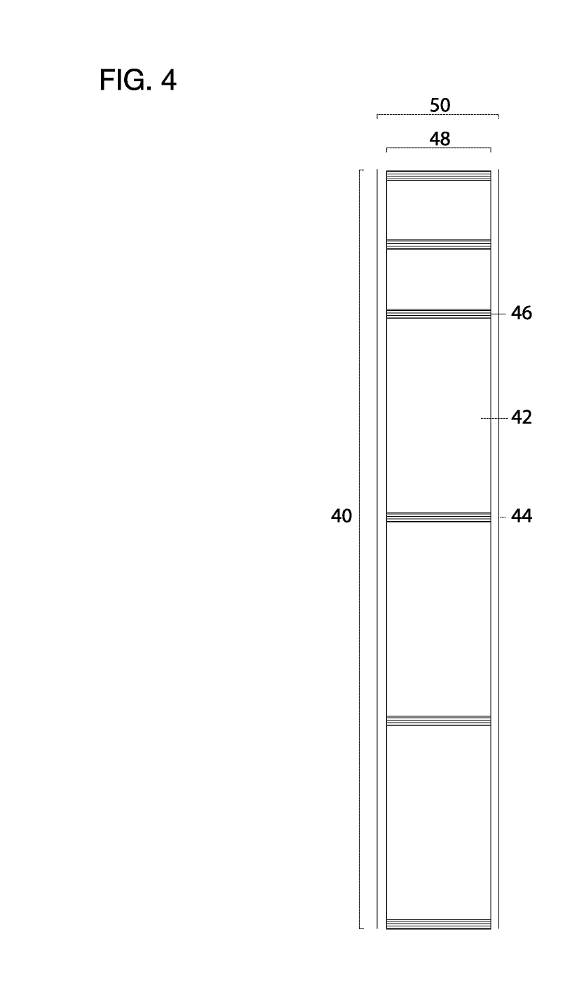

FIG. 4 depicts an alternate embodiment of a leash 40 having first strip of flexible material 42 and a second strip of flexible material 44, where the strips are separate pieces of material. First strip 42 has a first width 48 and wider second strip 44 has a larger, second width 50. The stitches 46 need not extend any further than the narrow first width 48. When a hand of a user grasps the leash 40, the first strip 42 might used as the inner layer, against the palm. The strips may be made of different materials, and may be of different lengths so that a longer strip loops back and is bound to itself to form hand hold loops at the ends.

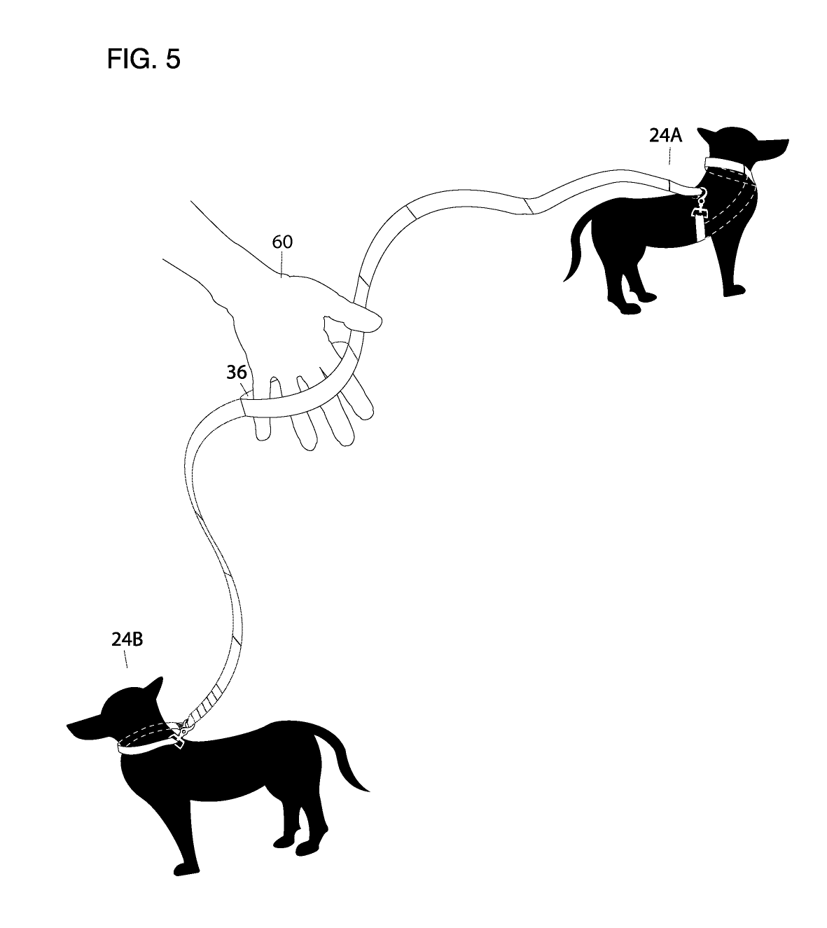

FIG. 5 depicts an embodiment of a leash 10 in use by a user having a hand 60 inserted into a hand hold apertures 36. An end of the leash may wrap around one dog's neck and body to create a harness and then the clasp 24A can be attached to the tether to retain the animal. A clasp 24B at the other end of leash 10 may be attached to an attachment aperture to form an adjustable collar for a second dog. In an alternate usage, the user may attach a second leash having a hand hold to one of the hand-hold apertures and use the hand hold of the second leash, so that the user can handle the animals using the second leash.

I claim:

1. A device utilizing a hand of a user, comprising:
two strips of flexible material, bound together to form a leash;
a first end of the leash having a hand hold loop and a first attachment clasp;
a second end of the leash having a second attachment clasp;
a first binding section near the first end of the leash having a first plurality of bindings joining the strips, the space between each binding providing an attachment aperture adapted to be retained by the second attachment clasp; and
a second binding section at and around the center of the leash having a second plurality of bindings joining the strips of flexible material, the space between each binding providing a hand-hold aperture adapted to be retained by the hand of the user.

2. The device of claim 1, further comprising:
a third binding section near the second end of the leash having a third plurality of bindings joining the strips, the space between each binding providing an attachment aperture adapted to be retained by the first attachment clasp.

3. The device of claim 2, wherein the first binding section and the third section binding section have substantially the same dimensions so that the leash is symmetrical.

4. The device of claim 1, wherein each of the first plurality of bindings is spaced laterally apart at a first binding interval to provide a first consistent size for the attachment apertures, and the second plurality of bindings is spaced laterally apart at a second binding interval to provide a second consistent size for the hand-hold apertures.

5. The device of claim 1, wherein the first aperture at the first end of the leash is further adapted to retain the first clasp, thereby retaining the first clasp on the leash for storage of the first clasp.

6. The device of claim 1, wherein both strips are a single piece of flexible material, folded onto itself to provide the leash.

7. The device of claim 1, wherein the leash includes a flat cord wrapped against itself to form the two strips and the hand hold loops at both ends of the strips, and two ends of the cord overlap each other in an overlapping portion where the cord is bound against itself to form a continuous loop.

8. The device of claim 1, wherein the two strips of flexible material have different widths to provide a wide strip and a narrow strip, the narrow strip is located within an area of the wide strip, and the strips are bound together only across the width of the narrow strip

9. The device of claim 1, wherein the strips include nylon or leather, the strips are bound together with stitching, and the portion of the leash at the base of each hand hold loop has a reinforced section that is at least as long as the first binding interval.

9. The device of claim 1, wherein the first binding section is spaced at an interval of between 0.8 to 2.5 inches, thereby accommodating attachment and removal of the second clasp, the first binding section extends between 11 inches and 13 inches, thereby providing a selection of attachment sizes, and the second binding interval is 5 inches to 7 inches, thereby accommodating insertion and convenient grasping by the user's hand.

10. The device of claim 1, wherein the attachment clasps are adapted to releasably retain collars for two animals to be tethered and walked by the user.

11. A leash comprising:
two strips of flexible material, bound together;
a first end of the leash having a first hand hold loop and a first attachment clasp;
a second end of the leash having a second hand hold loop and a second attachment clasp;
a first binding section near the first end of the leash having a first plurality of bindings joining the strips, having a first interval between each binding to provide attachment apertures adapted to be retained by the second attachment clasp;
a second binding section at and around the center of the leash having a second plurality of bindings joining the strips of flexible material, having a second interval between each binding to provide hand-hold apertures adapted to be retained by a user's hand; and
a third binding section near the second end of the leash having a third plurality of bindings joining the strips, having the first interval between each binding to provide attachment apertures adapted to be retained by the first attachment clasp;
wherein the first binding section and the third section binding section have substantially the same dimensions so that the leash is symmetrical.

12. A method of handling two animals, comprising:
providing a leash having two strips of flexible material, bound together, a first end of the leash having a hand hold loop and a first attachment clasp, a second end of the leash having a second attachment clasp, a first binding section near the first end of the leash having a first plurality of bindings joining the strips, the space between each binding providing an attachment aperture adapted to be retained by the second attachment clasp, and a second binding section at and around the center of the leash having a second plurality of bindings joining the strips of flexible material, the space between each binding providing a hand-hold aperture adapted to be retained by the hand of the user;
attaching a first animal to the first end of the leash utilizing the first attachment clasp;
attaching a second animal to the second end of the leash utilizing the second attachment clasp; and
inserting the user's hand into one of the hand-hold apertures thereby allowing the user to handle both animals.

13. The method of claim 12, further comprising:
releasing the first animal from the first attachment clasp; and
moving the user's hand from the hand-hold aperture to the first hand hold loop, thereby allowing the user to handle the second animal alone.

14. The method of claim further comprising:
attaching a second leash having a hand hold to one of the hand-hold apertures; and
handle the animals using the second leash.
